(19) United States
(12) Patent Application Publication
(10) Pub. No.: US 2011/0110650 A1
(43) Pub. Date: May 12, 2011

(54) METHOD AND SYSTEM FOR REAL-TIME VIDEO PLAYBACK

(75) Inventor: Ian Xie, Redwood City, CA (US)

(73) Assignee: Ipera Technology, Inc., Redwood City, CA (US)

(21) Appl. No.: 12/899,376

(22) Filed: Oct. 6, 2010

Related U.S. Application Data
(60) Provisional application No. 61/249,235, filed on Oct. 6, 2009.

(51) Int. Cl. H04N 5/93

(52) U.S. Cl. 386/353; 386/E05.003

(57) ABSTRACT

The present invention relates in general to real-time video play back techniques. More specifically, various video enhancement processes are performed using dedicated processors or computational threads for specific types of videos. In an embodiment, whether to perform peaking or deblocking processes for a video is determined based on characteristics of video being displayed. Depending on the application, video display architecture based on line-buffer is provided, which helps reduce battery usage. There are other embodiments as well.

### CROSS-REFERENCES TO RELATED APPLICATIONS

This application claims priority to Provisional Application No. 61/249,235 filed Oct. 6, 2009, which application is commonly owned and incorporated by reference herein for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates in general to real-time video play back techniques. More specifically, various video enhancement processes are performed using dedicated processors or computational threads for specific types of videos. In an embodiment, whether to perform peaking or deblocking processes for a video is determined based on characteristics of video being displayed. Depending on the application, video display architecture based on line-buffer is provided, which helps reduce battery usage. There are other embodiments as well.

Over the last decade, with advent of consumer electronics and more specifically media players (e.g., DVD player, computer, portable multimedia devices, cellular phones, etc.) are used for playing media contents in various formats. For a variety of reasons, media contents often need to be decompressed and processed (e.g., enhanced, adjusted, etc.) before they are presented for viewing and/or other purposes.

Typically, video enhancements include a de-interlacing, removing compression artifacts, scaling, etc. For these, certain conventional techniques have been developed and improved. Some of the conventional techniques such as noise reduction, contrast enhancement, etc., are derived from traditional image processing techniques. As a result, these techniques are often inadequate, especially for real time applications. For example, various applications such as video enhancements are performed without regard to the specific characteristics for the video. As a result, these conventional techniques often lead to poor performance and unacceptable output.

Hence it is highly desirable to improve techniques for providing video enhancement in video playback.

### BRIEF SUMMARY OF THE INVENTION

The present invention relates in general to real-time video play back techniques. More specifically, various video enhancement processes are performed using dedicated processors or computational threads for specific types of videos. In an embodiment, whether to perform peaking or deblocking processes for a video is determined based on characteristics of video being displayed. Depending on the application, video display architecture based on line-buffer is provided, which helps reduce battery usage. There are other embodiments as well.

According to an embodiment, the present invention provides a system for providing video playback. The system includes a first video interface for receiving a video file. The video file is associated with a first frame rate. The system includes a decoding module that is configured to process and decode the video file. The decoding module is configured to synchronize to the first frame rate. The system also includes a video estimator module that is configured to determine a blockiness level associated with the video file. The system additionally includes a first video processing module that is configured to perform at least a deblocking process. The system includes a second video processing module that is configured to perform at least a peaking process. The system also includes a control module that is configured to select either the first video processing module or the second video processing module for processing the video file based on at least the blockiness. The system includes a second video interface that is electrically coupled to a display. The second video interface is configured to output video processed by the first video module or the second video processing module.

According to another embodiment, the present invention provides method for providing video playback. The method includes receiving a video file at a first interface module. The video file is associated with a first frame rate. The method also includes decoding the video file at a second frame rate. The method further includes determining a blockiness level associated with the video file. The method also includes comparing the blockiness level with a predetermined threshold level. If the first level is higher than the threshold level, a first plurality of processes is selected to perform on the first frame. The first plurality of processes includes a deblocking process performed by a deblocking process module. If the first level is lower than the threshold level, a second plurality of processes is selected to perform on the first frame. The first plurality of processes includes a peaking process performed by a peaking process module. The method also includes performing the selected plurality of processes. The method includes outputting the first frame.

According to yet another embodiment, the present invention provides a system for providing video playback. The system includes a first video interface for receiving a video file that is associated with a first frame rate and a first format. The system also includes a decoding module that is configured to process and decode the video file. The system further includes a video estimator module that is configured to determine blockiness associated with the video file. The system includes a first video processing module that is configured to perform at least a deblocking process. The first video processing module is configured to process two or more lines of pixels at a time. The system further includes a second video processing module that is configured to perform at least a peaking process. The system also includes a control module that is configured to select either the first video processing module or the second video processing module for processing the video file based on at least the blockiness. The system includes a rendering module configure to covert the processed video to a second format.

It is to be appreciated that embodiments according to the present invention offer various advantages over conventional techniques. For example, the embodiments of the present invention provide an efficient solution for enhancing videos and/or images. In a specific embodiment, the present invention provides a mechanism for an optimal use of processing resources by using dedicated video processor and/or processing resources for specific types of video. The processes that are used to enhance video files that are content independent. By deploying a dual-mode processing mechanism, a system according embodiments of the present invention plays back both broadcast quality (higher quality) and consumer generated content (UGC, lower quality) at much higher quality than conventional players. In a preferred embodiment, the present invention provides an efficient architecture that is takes the advantage of line-buffer to achieve much better cache performance, which is particularly useful for battery powered devices such as smart phones and portable media players. Furthermore, embodiments of the present invention can be integrated into conventional systems with ease. In one embodiment, the video processing techniques are provided by a dedicated video processing module that can be integrated into conventional media playback devices. For example, various embodiments of the present invention are implemented as software modular components in a general purpose computer. As another example, various embodiments are implemented with currently available hardware components, such as hardware decoders, memory components, etc. There are other benefits as well.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram illustrating a system according to an embodiment of the present invention.

FIG. 1A is a simplified block diagram illustrating a media device according to an embodiment of the present invention.

FIG. 2 is a simplified block diagram illustrating dual-mode architecture for video playback.

FIG. 3 is a simplified diagram illustrating a process for determining blockiness level according to an embodiment of the present invention.

### DETAILED DESCRIPTION OF THE INVENTION

The present invention relates in general to real-time video play back techniques. More specifically, various video enhancement processes are performed using dedicated processors or computational threads for specific types of videos. In an embodiment, whether to perform peaking or deblocking processes for a video is determined based on characteristics of video being displayed. Depending on the application, video display architecture based on line-buffer is provided, which helps reduce battery usage. There are other embodiments as well.

Embodiments of present invention provide a system that performs a number of video enhancement processes, such as peaking, deblocking, dynamic contrast enhancement, color enhancement, and others. Specific video enhancement techniques are described in U.S. patent application Ser. No. 12/270,433, filed Nov. 13, 2008, and U.S. patent application Ser. No. 11/925,744, filed Oct. 26, 2007, which are incorporated by reference herein for all purposes.

As discussed above, conventional techniques for processing images and videos are often inadequate. More specifically, various conventional video processing solutions are not flexible and efficient enough to process and/or enhance various types of videos in real-time applications. In certain scenarios, software video process solutions require more processing power than is available. As a result, performance of conventional video solutions is often inadequate. For example, various video processing solutions may work for certain systems but not others, as certain systems may be slower or use processing power for other applications. As described below, it is to be appreciated that embodiments of the present invention provide techniques that allow processing of video and/or graphics to be dynamically determined based on various factors based on the video and/or graphics.

There are many image and video enhancement processes. For example, color and contrast enhancements are often performed to improve perceived image or video for the viewer. The color enhancement process typically causes the color of images to look more vivid or vibrant. The contrast enhancement process typically renders the difference between the bright areas and dark areas more visually pronounced. Generally, contrast enhancement and color enhancement processes compliment each other.

Often, it is desirable to perform multiple enhancement processes on the same video, such as performing both color and contrast enhancement processes. In other situations, it is often undesirable to perform two processes on the same video. For example, the deblocking process usually involves smoothing the transition among groups of pixels. Peaking processes, on the other hand, typically make transitions more pronounced. When used together, deblocking and peaking processes often undermine the effectiveness of each other. In addition, valuable computation resources are wasted. Thus, it is desirable to perform only one of the two conflicting processes.

It is to be appreciated that various embodiments of the present invention select video or image enhancement processes based on the video and/or image characteristics. For example, if a video is determined to be blocky, deblocking process is performed, but peaking process is not performed. The details of the present invention are described below.

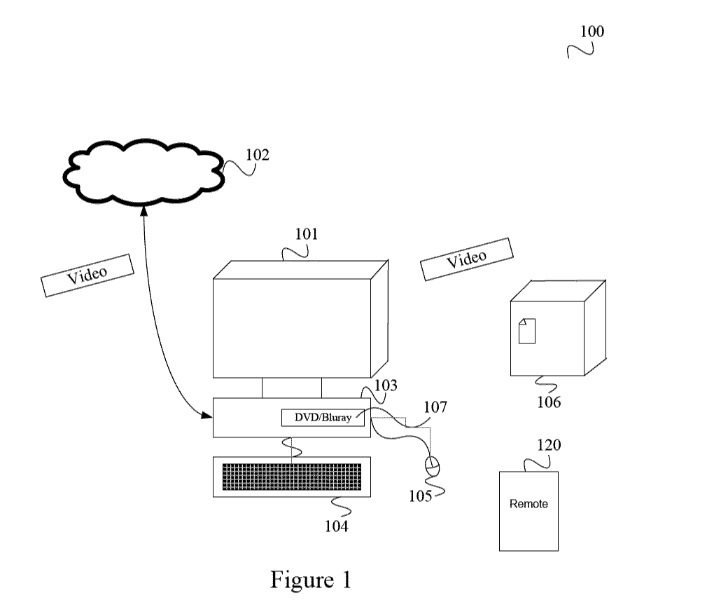

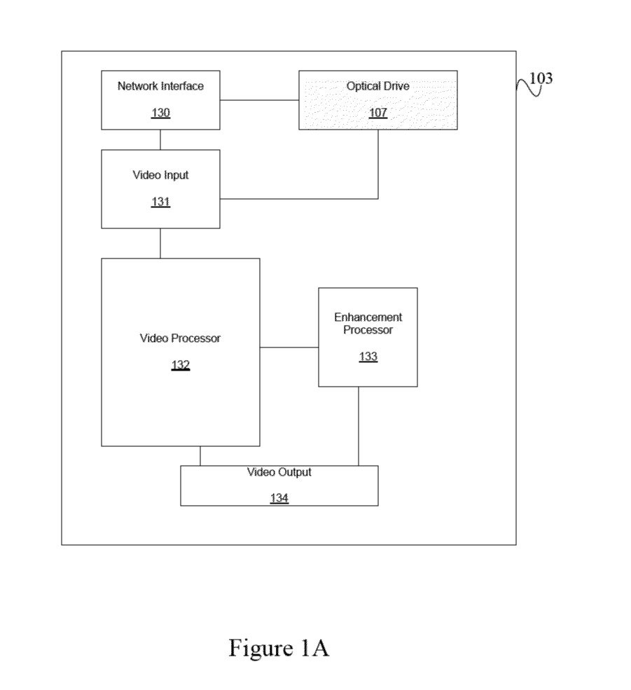

FIG. 1 is a simplified diagram illustrating a system according to an embodiment of the present invention. This diagram is merely an example, which should not unduly limit the scope of the claims. One of ordinary skill in the art would recognize many variations, alternatives, and modifications. As shown in FIG. 1, a system 100 includes a display 101, a media device 103, an optical drive 107, a keyboard 104, a mouse 105, a network 102, and a media source 106. The system 100 is specifically configured to display video and/or images. The media device 103 includes various modules for processing video. An exemplary media device is illustrated in FIG. 1A and described below.

It is to be appreciated that the embodiments of the present invention can be implemented using a variety of devices. For example, system 100 as illustrated in a personal computer that includes, among other features, video processing modules. The video processing techniques of the present invention can also be implemented with media players, mobile phones, personal digital assistants, video player, DVD/Blu-ray player, display units (e.g., television, monitors), gaming devices, and others. In a way, portable electronics and media player devices today often share many features and components of a personal computer. It is to be appreciated that, throughout the present application, the term “module” refers to a functional unit, which can be implemented by one or more hardware components; similarly, multiple modules as referred to in the present application can be implemented by a single hardware unit.

According to various embodiments, system 100 obtains videos through various sources. For example, system 100 receives stream video from network 102. For example, network 102 is connected to the Internet and system 100 receives the streaming video through the Internet. As another example, system 100 retrieves a video file from its own storage system. In yet another example, system 100 gets video files from media source 106, which may be a cable box, an external storage unit, a DVD player, a game console, etc.

In one specific embodiments, keyboard 104 and mouse 105 are used to provide user input. In alternative embodiments, a remote control 120 is used for receiving user inputs in lieu of in combination with keyboard 104 and mouse 105. In various embodiments, user input is implemented with other devices, such as a touch screen, cell phone, thumb board, remote controller, etc.

According to an embodiment, display 101 provides video display and/or user interface. For example, display 101 may be an LCD display, a CRT display, a plasma display, a projector, etc. Depending on the application, system 100 may include additional display components. In one embodiment, the media device 103 is integrated into the display device. For example, the display 101 is an LCD television that can be connected to the Internet through its network interface and is capable of processing and enhancing video for real-time playback.

In certain embodiments, system 100 as shown is implemented using a general purpose computer. In various applications, system 100 may be implemented with a mobile device, a media player, a television, etc.

FIG. 1A is a simplified block diagram illustrating a media device according to an embodiment of the present invention. This diagram is merely an example, which should not unduly limit the scope of the claims. One of ordinary skill in the art would recognize many variations, alternatives, and modifications. Depending on the application, the media device 103 shown in FIG. 1A can be used as a part of television processing module, standalone media player, cable set-top box, Bluray player, DVD player, mobile phone, personal media player, and others.

As shown in FIG. 1A, the media device 103 includes the following components:

1. Network interface 130;

2. Optical drive 107;

3. Video input interface 131;

4. Video processor 132;

5. Enhancement processor 133; and

6. Video output interface 134.

The video input interface 131 receives video file and/or video streams from various media sources. As shown, the video input interface 131 is connected to the network interface 130. For example, the video input source receives video streams from the network interface 130. Depending on the application, the network interface 130 may include Ethernet port, WIFI interface, powerline communication network interface, and others. The network interface 130 may receive stream video from a variety of sources, such as Internet, local area network, nearby network enabled media device, and others.

The video input interface 131 is also connected to the optical drive 107. For example, the optical drive 107 can be a video CD player, a DVD player, a Bluray player, or other types of media player. It is to be appreciated that the video input interface 131 may be connected to other types of media sources as well, such as flash drive, camera, camcorder, personal media player, cable television, television antenna, and other. In one embodiment, the video input interface 131 comprises a demodulating module for demodulating over-the-air television signals.

When a video file and/or video stream is received by the video input interface 131, various properties of the video file and/or video stream is determined. For example, these properties include media format, media source, resolution, frame rate, compression or coding type, bit rate, size, etc. As mentioned above, if a video is received as television signals over-the-air or via cable television box, demodulation process is performed.

The video processor 132 is configured to process the video. The video processor 132 is configured to decode the video and/or video stream if needed. For example, the video processor 132 determines a compression method (e.g., MPEG, H.264, etc.) associated with the video file and decodes the video file using proper decoding algorithm. In one specific embodiment, the video processor 132 includes a dedicated decoding chip for decoding video files in various formats.

The video processor 132 performs scaling processes as needed. For example, the media device 103 is configured to provide video signals for display at one or more resolutions. The video processor 132 analyzes the resolution of the video file and determines if scaling is needed. For example, if the video file received by the video input interface has a resolution different from the desired output resolution, the video processor 132 performs a scaling process to scale up or down the video resolution. Depending on the specific application and/or settings, the video processor 132 may maintain or change the aspect ratio during the scaling processes. In one specific embodiment, the video processor 132 includes a dedicated decoding chip for scaling video files in various sizes.

In various embodiments, the video processor 132 determines a blockiness level of the video processed. An exemplary process of blockiness level determination is described below.

It is to be that the video processor 132 can be implemented in various ways. For example, scaling and decoding processes may be performed by dedicated chips on the video processor 132, or by a general video processing module. The video processor 132 may include other components as wall, such a buffer memory for caching one or more frames of video, module for adjusting frame rate, and others.

The video processor 132 is connected to the enhancement processor 133. The enhancement processor 133 is a processing module that is specifically designed to perform one or more video enhancement processes. In various embodiments, the enhancement processor 133 is a dedicated and energy-efficiency processor for enhancing quality of video that is less than a certain resolution or size. In one specific embodiment, the enhancement processor 133 is configured to enhance video in two modes: P-mode and D-mode. For example, if the video is determined to be blocky, D-mode is selected and deblocking process is performed. On the other hand, if the video is not blocky, then P-mode is selected and peaking process is performed. Depending on the application, other enhancement processes, such as dynamic contrast enhancement and color enhancement, can be performed as well.

The enhancement processor 133 can be implemented on the media device in various ways. In one specific embodiment, the enhancement processor 133 is mounted on the PCB board as the video processor 132 and is connected to the video processor 132.

The enhancement processor 133 is configured to perform a variety of video enhancement processes. For example, the enhancement processor 133 is configured to selectively perform deblocking, de-mosquito, de-noise, color enhancement, contrast enhancement, bright level adjustment, detail enhancement, and other types of enhancements. In one embodiment, the enhancement processor 133 analyzes video quality to determine what types of enhancements are to be performed. For example, the enhancement processor selects from either performing do-noise process or detail enhancement processes, as these two processes reverse the effects of each other. In a specific embodiment, the enhancement processor 133 is configured to perform video processing in multiple modes. Multiple-mode video processing is described in the patent application “System and Method for Multi-Mode Video Processing,” U.S. patent application Ser. No. 12/624,373, filed Nov. 23, 2009, which is incorporate by reference herein for all purposes.

As mentioned above, enhancement processes are only performed for certain types of video. More specifically, the video processor 132 may determines whether to use the enhancement processor 133 for video enhancement based on resolution, frame rate, video size, blockiness and/or other criteria.

The video output interface 134 is configured to provide video signals to one or more display devices. In various embodiments, the video output interface 134 comprises VGA, composite video, component video, s-video, HDMI, DVI, and/or other types of interfaces. In another embodiment, the video output interface 134 is connected to a display by an internal data bus (e.g., connecting between a video output and the LCD display of a cellular phone).

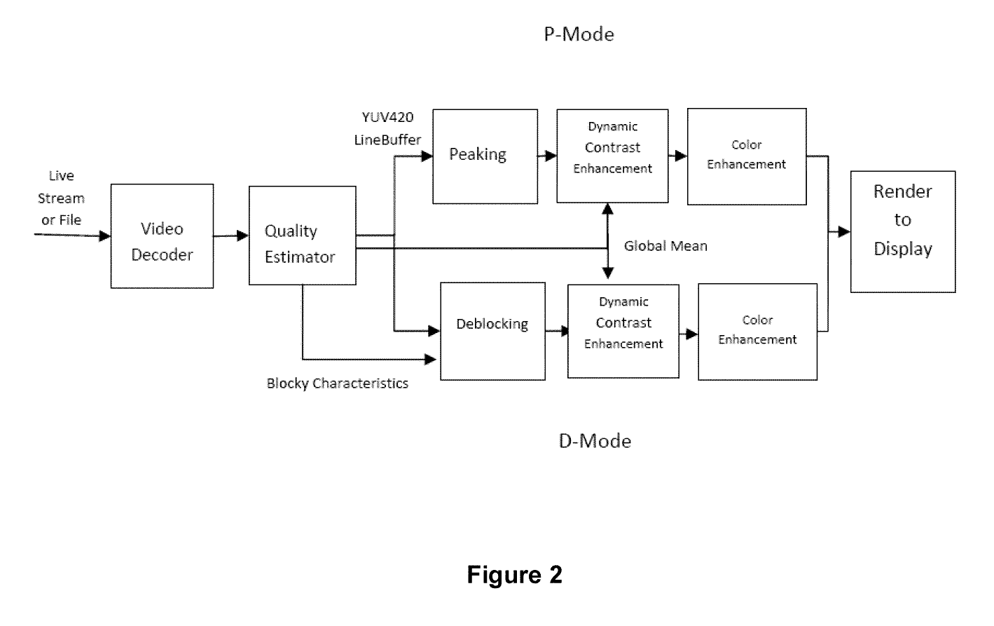

FIG. 2 is a simplified block diagram illustrating a dual-mode architecture for video playback. This diagram is merely an example, which should not unduly limit the scope of the claims. One of ordinary skill in the art would recognize many variations, alternatives, and modifications.

As shown in FIG. 2, a video playback architecture includes the following modules:

1. video decoder;

2. quality estimator;

3. deblocking module;

4. peaking module;

5. dynamic contrast enhancement module;

6. color enhancement module; and

7. rendering module.

Depending on the application, each the of above modules can be implemented as hardware module, software module, a process thread performed by a processor, or others.

The video decoder is configured to decode video file or bitstream one frame at a time. The video decoder, as needed, also performs proper synchronization to maintain the frame rate as specified in the bitstream (i.e. 30 frames per second).

The quality estimator is configured to determine if the decoded video is blocky or not. One possible embodiment is to measure the transition across the 8×8 block boundary and count how many 8×8 blocks can be classified as blocky. If more than certain number of blocks are blocky, then the video sequence is considered blocky.

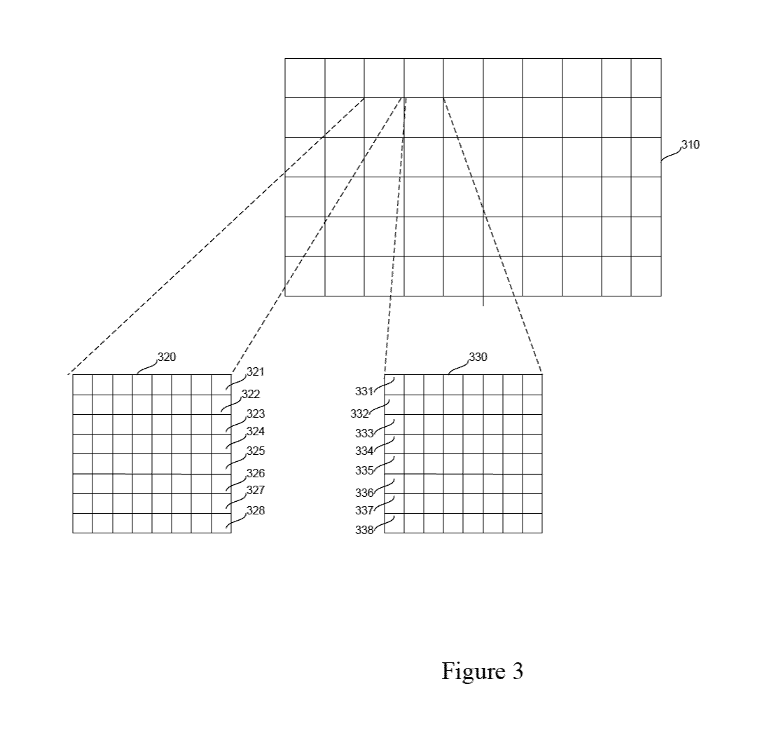

There are various ways for detecting blockiness of a video frame. FIG. 3 is a simplified diagram illustrating a process for determining blockiness level according to an embodiment of the present invention. This diagram is merely an example, which should not unduly limit the scope of the claims. One of ordinary skill in the art would recognize many variations, alternatives, and modifications.

As shown in FIG. 3, a video frame 310 is divided into a predetermined number of blocks. In one embodiment, each block has 8×8 pixels. Depending on the application, each block may also have different sizes (e.g., 3×3, 4×4, 6×6, etc.) and/or dimensions. For example, for a video frame of 320×240 pixels, there are 40×30 blocks, each block having 8×8 pixels. In one embodiment, the 8×8 pixel block size is used since 8×8 pixel blocks are often used during a discrete cosine transform process.

To determine whether a video frame is blocky, a number of blocks are examined. For example, the block 320 is processed. As shown in FIG. 3, the right edge of the block 320 includes a column of pixels 321-328. Pixels 321-238 are compared against the edge of the block 330. For example, the total difference between the column of pixels 321-328 and the column of pixels 331-338 is an indication of a hard edge of the border, which could be a result of an artificial block. For example, the following equation is used to determine the differences of the adjacent edges between the blocks 320 and 330:

$${\sum }_{1}^{8} ‖ P 1 - P 2 ‖ = BlockyLevel$$

For example, the P1 and P2 are two adjacent pixels (e.g., pixel pairs 321 and 331, 322 and 332, etc.). The absolute value of the difference between P1 and P2 is accumulated for the column. The accumulated difference value is used as an indication of the blockiness. For example, if the blockiness value is greater than a threshold value, then the block 320 is determined to be “blocky”. In one embodiment, if the number of “blocky” blocks of the video frame 310 is greater than a predetermined threshold, then the video frame 310 is deemed blocky. In another embodiment, the “blockiness” value of each block is summed as a total blockiness value for the video frame 310, and the video frame 310 is deemed blocky if the total blockiness value is greater than a predetermined threshold value.

It is to be appreciated that there are various ways for determining whether a video frame is blocky. For example, a line-by-line comparison may be performed to identify patterns in blocky video.

In various embodiments, the blockiness level is determined by looking at more than one frames. For example, a plurality of processes to determine whether a video segment is noisy.

Now referring back to FIG. 2.

If the video sequence is determined to be blocky, the video player is switched into D-mode. For example, D-Mode comprises a deblocking process (and possibly de-mosquito and de-ringing when processing power allows) followed by other enhancement processes such as Dynamic Contrast Enhancement (DCE) and Color Enhancement (CE).

If the video sequence is determined to be not blocky, the video player is switched into P-Mode. P-Mode comprises a deblocking process that enhances details and edges in the video to make it look sharper, followed by other enhancement blocks such as Dynamic Contrast Enhancement (DCE) and Color Enhancement (CE).

It is to be appreciated that, as explained above, it is helpful to process video using either P-Mode or D-Mode, as peaking and deblocking process (which may include de-mosquito, de-ringing processes) are two conflicting processes. Running only one of the two process based on the blockiness of the video helps achieve optimal quality for video. Typically, for low quality clips (such as user generated content from cell phone camera), it usually falls into D-Mode, since blockiness and mosquito noise are common in the content due to lower quality capture and compression. Therefore, it would be desirable to “clean up” video using D-Mode.

On the other hand, for broadcast (or typically high) quality video clips, it usually preferably to use P-Mode, as good quality content (such as H.264 based broadcast clips) is often soft after compression and can benefit from more details and give the impression of sharper and clearer video.

It is to be appreciated that to achieve optimal performance, embodiments of the present invention provides algorithms used in P-Mode and D-Mode that work on several lines of video data at a time, which has the advantage of having less data in the cache at one time (several lines instead of an entire frame of video data). Among other things, processing multiple lines at a time help achieve better memory subsystem performance. For example, when processing is completed on a fixed number of lines, the next fixed number of lines are loaded and processed. To accomplish this, before the data passed into either P-Mode or D-Mode processing a video frame is divided into group of lines and processed one group of lines at a time. The processed lines are then assembled to at the renderer to form an output

As described above, a goal in P-Mode processing, which includes peaking process, is to enhance details. In an exemplary embodiment, a peaking process is performed in three steps:

a) Detect the biggest transition in a 3×3 block centered at current pixel. This could be one of

two directions: 0 or 90°. Or if processing power permits, one of four directions: 0, 45°, 90°, or 135°;

b) Apply a high pass filter along the biggest transition direction.

c) Apply a low pass filter along the direction perpendicular to the biggest transition. For example, if high-pass is applied along a 0° angle, low-pass should apply along a 90° angle. If high-pass applies along 45°, low-pass will apply along 135°.

Steps b) and c) can be combined into one filter which simultaneously perform high-pass at the biggest transitional direction while perform low-pass filter at the perpendicular direction.

The lines of data output from peaking process is then fed into the Dynamic Contrast Enhancement (DCE) block. In various embodiments, the DCE block also receives a Global Mean value information from the Quality Estimator. For example, global Mean value is obtained by averaging all, or substantially all the pixel values in the current frame of video. The DCE block then uses a lookup table generated or pre-stored based on the Global Mean to change the pixel luminance value so that the pixels have a large dynamic range and better contrast. For each pixel, Y′=DCE_Table[Global Mean][Y]. In a specific embodiment, a two dimensional lookup table is used. The table can also be dynamically generated based on the Global Mean and the look up will be only one dimensional based on the luminance Y. It is to be appreciated that lookup table method is general faster than performing calculation. It is to be understood that there are other ways of performing contrast enhancement as well.

The lines of data output from Dynamic Contrast Enhancement is then fed into the Color Enhancement (DCE) block. The color enhancement adjust the chrominance components (e.g., U and V component) of each pixel on these lines. Both U and V are subtly increased according to a pre-stored lookup table so that saturation will be improved to make the video look more colorful and vivid. This table is designed as a one dimensional table with 256 entries. U′=CE_Table[U] V′=CE_Table[V]

It is to be appreciated that lookup table method is general faster than performing calculation. It is to be understood that there are other ways of performing color enhancement as well.

Now referring to the D-Mode processes. In D-Mode, lines of data are copied into a Line Buffer and fed into the deblocking module. In an embodiment, the deblocking module operates on one 8×8 block (e.g., 64 total pixels) at a time. The deblocking module performs low-pass smoothing filter to smooth out the blockiness artifact across the 8×8 block boundary. The deblocking module can also accept values (such as Blocky Characteristics) from the quality estimator module which holds the a blockiness value and location of the boundary (or both boundaries) where blockiness occurs. By taking the blockiness level into account, the deblocking process is performed more efficiently, as it is possible to avoid smoothing out details at the 8×8 boundaries. It is to be appreciated that de-blocking process can be performed in other ways as well.

The lines of data output from Deblocking is then fed into the Dynamic Contrast Enhancement (DCE) block. In various embodiments, the DCE block also receives a Global Mean value information from the Quality Estimator. For example, global Mean value is obtained by averaging all, or substantially all the pixel values in the current frame of video. The DCE block then uses a lookup table generated or pre-stored based on the Global Mean to change the pixel luminance value so that the pixels have a large dynamic range and better contrast. For each pixel, Y′=DCE_Table[Global Mean][Y]. In a specific embodiment, a two dimensional lookup table is used. The table can also be dynamically generated based on the Global Mean and the look up will be only one dimensional based on the luminance Y. It is to be appreciated that lookup table method is general faster than performing calculation. It is to be understood that there are other ways of performing contrast enhancement as well.

Once enhancement processes, either in P-Mode or in D-Mode, are performed, the video is rendered. In an embodiment, a rendering module is used. For example, the rendering module assembles lines of processed pixels into a YUV420 frame (e.g., either interleaved or planar). The combined lines are rendered to the display engine to show on display. If the display engine doesn't accept YUV420, the video frame data are converted into the format supported by the display engine and then rendered to display engine to show on screen.

It is to be appreciated that various modules illustrates ion FIG. 2 and various process described above can be modified, replaced, removed, and/or rearranged. For example, it is possible to add more artifacts removal modules into D-Mode, such as de-mosquito or de-ringing modules before or after de-blocking module.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for providing video playback comprising:
a first video interface for receiving a video file, the video file being associated with a first frame rate;
a decoding module, the decoding module being configured to process and decode the video file, the decoding module being configured to synchronize to the first frame rate;
a video estimator module, the video estimator module being configured to determine a blockiness associated with the video file;
a first video processing module, the first video processing module being configured to perform at least a deblocking process;
a second video processing module, the second video processing module being configured to performed at least a peaking process;
a control module, the control module being configured to select either the first video processing module or the second video processing module for processing the video file based on at least the blockiness; and
a second video interface, the second video interface being electrically coupled to a display, the second video interface being configured to output video processed by the first video module or the second video processing module.

2. The device of claim 1 further comprising a rendering module for assembling lines of pixels processed by the first video module or the second video processing module.

3. The device of claim 1 wherein the decoding module is further configured to determine an average value based on pixel values of a video frame.

4. The device of claim 1 wherein the video estimator module is further configured to calculate a global mean value, the global mean value being a function of average pixel values of a frame from the video file.

5. A method for providing video playback, the method comprising:
receiving a video file at a first interface module, the video file being associated with a first frame rate;
decoding the video file at a second frame rate;
determining a blockiness level associated with the video file;
comparing the blockiness level with a predetermined threshold level;
if the first level is higher than the threshold level, selecting a first plurality of processes to perform on the first frame, the first plurality of processes comprising a deblocking process performed by a deblocking process module;
if the first level is lower than the threshold level, selecting a second plurality of processes to perform on the first frame, the first plurality of processes comprising a peaking process performed by a peaking process module;
performing the selected plurality of processes; and
outputting the first frame.

6. The method of claim 5 further comprising selecting an 8×8 block of pixels for determining the blockiness level.

7. The method of claim 5 wherein the deblocking process module performs at least a low-pass filtering process.

8. The method of claim 5 further comprising calculating the blockiness level by at least measuring a transition across a block of pixels.

9. The method of claim 5 wherein the peaking process is performed on at least two lines of the video file.

10. The method of claim 5 wherein the peaking process comprises:
determine a first transition direction based on pixels around a center pixel;
applying a high pass filter along the first transition direction;
applying a low pass filter along a second direction, the second direction being perpendicular to the first direction.

11. The method of claim 5 further comprising processing video information.

12. The method of claim 5 further comprising calculating an average value associated with pixel values associated with a frame of the video file.

13. The method of claim 5 further comprising performing a dynamic contrast enhancement.

14. The method of claim 5 further comprising combining lines of pixels into a YUV420 frame.

15. The method of claim 5 further comprising performing color enhancement process by using a lookup table.

16. The method of claim 5 further comprising performing contrast enhancement process by using a lookup table.

17. The method of claim 5 wherein the first frame rate and the second frame rate and synchronized.

18. A system for providing video playback comprising:
a first video interface for receiving a video file, the video file being associated with a first frame rate and a first format;
a decoding module, the decoding module being configured to process and decode the video file;
a video estimator module, the video estimator module being configured to determine a blockiness associated with the video file;
a first video processing module, the first video processing module being configured to perform at least a deblocking process, the first video processing module being configured to process two or more lines of pixels at a time;
a second video processing module, the second video processing module being configured to performed at least a peaking process;
a control module, the control module being configured to select either the first video processing module or the second video processing module for processing the video file based on at least the blockiness; and
a rendering module configure to covert the processed video to a second format.

19. The system of claim 18 further comprising a display module.

20. The system of claim 18 further comprising an audio module for processing audio information associated with the video file.
